(19) United States
(12) Patent Application Publication
(10) Pub. No.: US 2025/0165300 A1
(43) Pub. Date: May 22, 2025

(54) MULTI-CLOUD PLATFORM FOR MIGRATION AND DEPLOYMENT OF CLOUD SERVICES

(71) Applicant: NetApp Inc., San Jose, CA (US)

(72) Inventors: Saravanan SE, Tamilnadu (IN); Sridevi Tallapragada, Bangalore (IN); Pavan Kumar N, Hyderabad (IN); Jagannathan Asokan, Bangalore (IN)

(21) Appl. No.: 18/515,333

(22) Filed: Nov. 21, 2023

(51) Int. Cl. G06F 9/50; G06F 8/60

(52) U.S. Cl. CPC G06F 9/5055; G06F 8/60

(57) ABSTRACT

Techniques are provided for deploying and migrating services across cloud computing platforms. An organization incurs significant costs when hosting services of the organization on-premises using computing resources maintained by the organization. Instead, the services can be migrated to a cloud computing platform that provides scalable and lower cost computing resources for hosting the services. However, the cloud computing platform may not provide adequate performance or may be more costly than other cloud computing platforms. Unfortunately, migrating the services from the current cloud computing platform to another cloud computing platform is difficult, cumbersome, and generally not feasible (e.g., a service may need to be re-coded from scratch for a particular cloud computing platform). Accordingly, the techniques provided herein are capable of deploying services across multiple cloud computing platforms, and seamlessly migrating services and operational metadata of the services amongst different cloud computing platforms.

### TECHNICAL FIELD

Various embodiments of the present technology relate to deploying and migrating services across cloud computing platforms.

### BACKGROUND

Cloud computing has become one of the most powerful and widely used technologies in recent times, as it provides faster and more flexible access to servers, databases, storage, software, etc. While cloud computing benefits most organizations, there are certain limitations that hinder the use of cloud computing resources. One of the disadvantages is the cost of cloud computing resources. With an increase in the usage of services such as Platform as a Service (PAAS), the cost of cloud resources is on a constant rise over the years. Consequently, organizations are struggling with how to handle the growing expenditure for cloud resources.

Another disadvantage is that the existing cloud computing platforms do not support seamless migration of services from one cloud computing platform to a different cloud computing platform. Migration of a service may be desired when an organization wants to switch to a more cost effective or more performant cloud computing platform. There are technical challenges and restrictions when the organization attempts to migrate a deployed service (an existing cloud service) from a current cloud computing platform to a different cloud computing platform. For instance, the existing cloud computing platform restricts the organization from accessing and moving/migrating operational metadata associated with deployed service to a different cloud computing platform or to an on-premises deployment. Loss of operational metadata means that the organization must rebuild the services in the different cloud computing platform, which is time consuming, costly, and highly technical as the services may need to be recoded from scratch according to programming semantics supported by the different cloud computing platform. Consequently, such restrictions and technical challenges make migrating or moving the services from an existing cloud computing platform impractical.

Moreover, due to limitations in single vendor cloud computing platforms, organizations are moving towards a multi-cloud or hybrid cloud deployment scenario, at times referred to as a multi-cloud computing platform. A multi-cloud computing platform provides organizations with the ability to simultaneously use multiple cloud computing platforms from different cloud vendors within one architecture. However, existing multi-cloud solutions provide little to no guidance as to the feasibility of migrating to a multi-cloud computing platform. Without such guidance organizations are forced to make relatively uninformed decisions related to the cost of moving to a multi-cloud computing platform deployment and are unable to identify the essential services that need to be migrated and included as part of the multi-cloud computing platform deployment.

### DESCRIPTION OF THE DRAWINGS

Embodiments of the present technology will be described and explained through the use of the accompanying drawings in which:

FIG. 1 is a block diagram illustrating an embodiment of a system for deploying components of a service across multiple cloud computing platforms in order to migrate the service in accordance with an embodiment of the present technology.

FIG. 2 is a block diagram illustrating an embodiment of a system for deploying components of a service across multiple cloud computing platforms in order to deploy the service in accordance with an embodiment of the present technology.

FIG. 3A is a block diagram illustrating an embodiment of a system for obtaining a current cloud deployment script of a service to migrate in accordance with an embodiment of the present technology.

FIG. 3B is a block diagram illustrating an embodiment of a system for providing a deployment plan and recommendation for migrating a service in accordance with an embodiment of the present technology.

FIG. 4 is a block diagram illustrating an embodiment of a system for translating a current cloud deployment script into a service representation in accordance with an embodiment of the present technology.

FIG. 5 is a block diagram illustrating an embodiment of a system for translating a service request into a deployment script in accordance with an embodiment of the present technology.

FIG. 6 is a block diagram illustrating an embodiment of a system for translating a service request into a deployment script in accordance with an embodiment of the present technology.

FIG. 7 is a flow chart illustrating an embodiment of a method for deploying components of a service across one or more cloud computing platforms in accordance with various embodiments of the present technology.

FIG. 8 is a flow chart illustrating an embodiment of a method for deploying components of a service across one or more cloud computing platforms in accordance with various embodiments of the present technology.

FIG. 9 is a flow chart illustrating an embodiment of a method for deploying components of a service across one or more cloud computing platforms in accordance with various embodiments of the present technology.

FIG. 10 is a block diagram illustrating an example of a node in accordance with various embodiments of the present technology.

FIG. 11 is an example of a computer readable medium in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Various embodiments of the present technology relate to a multi-cloud deployment engine for deploying and migrating services across cloud computing platforms. Various types of services, such as a website hosting service, an email service, a chat bot, a text-to-speech service, and a variety of other services, can be hosted on-premises using local computing resources or within a cloud computing platform using cloud resources. Hosting a service on-premises is generally more costly and less scalable than hosting the service through the cloud computing platform that may provide scalable resources at a lower cost. Deployment of a service relies upon operational metadata describing how the service is to operate. The operational metadata specifies properties such as IP address properties, resource properties, load balancer properties, security properties, network properties, and/or a variety of other properties used to deploy and host the service.

If a user wants to migrate the service from on-premises or a current cloud computing platform to a destination cloud computing platform, then the user must manually recode the service such as by creating new operational metadata having a format that can be interpreted by the destination cloud computing platform. That is, each cloud computing platform may utilize its own proprietary format and programming semantics that are not supported by other cloud computing platforms. The existing operational metadata may be inaccessible to the user from the current cloud computing platform because cloud computing platforms generally do not expose such information to users. Even if the user can access the existing operational metadata, the existing operational metadata will be in a format specific to the current cloud computing platform, and cannot be reused to migrate the service to a different cloud computing platform. As part of recoding the service for the destination cloud computing platform, the user must generate a new deployment script from scratch because the deployment script must be tailored to programming semantics supported by the destination cloud computing platform. Because of the time and complexity to create new operational metadata and deployment descripts from scratch, users would not even consider migrating the service to a multi-cloud computing environment where each cloud computing platform would require its own operational metadata and deployment script.

In order to overcome these technical challenges, a multi-cloud deployment engine is provided. The multi-cloud deployment engine is capable of retrieving the operational metadata of the service from the current cloud computing platform, and transforming the operational metadata into a deployment script. The deployment script is formatted according the programming semantics specific to the destination cloud computing platform. In this way, the multi-cloud deployment engine can seamlessly migrate the service to the destination cloud computing platform.

The multi-cloud deployment engine is capable of migrating components of the service across multiple different cloud computing platforms in order to achieve a multi-cloud deployment arrangement for the service. The multi-cloud deployment engine evaluates deployment requirements of each component (e.g., a certain amount of compute resources, a certain amount of storage resources, network latency requirements, I/O processing bandwidth, expected performance such as I/O per second (IOPS), and/or other constraints, objectives, and considerations) and characteristics of available cloud computing platforms (e.g., performance and cost characteristics) in order to construct a deployment arrangement. The deployment arrangement is used to deploy certain components to select cloud computing platform in order to achieve certain objectives such as a lowest cost deployment, a more performant deployment, a baseline deployment that provides a baseline/minimum amount of resources needed for the service to operate, or any other type of objective. Different components may have different requirements, and thus certain cloud computing platforms may be better tailored for hosting a component compared to other cloud computing platforms (e.g., a compute intensive component may be more performant if hosted at a particular cloud computing platform, while an archival based storage component may be hosted at a lower cost at a different cloud computing platform). In this way, the multi-cloud deployment engine takes various considerations, constraints, and objectives into account when constructing the deployment arrangement used to deploy components of the service according to a multi-cloud deployment arrangement.

The multi-cloud deployment engine provides a multi-cloud computing platform that enables users to migrate, move, and deploy services (cloud services) with little to no downtime and in a cost-effective manner. The multi-cloud deployment engine allows live migration of cloud services that are deployed on a cloud computing platform. The cloud services are migrated from the cloud computing platform to one or more other cloud computing platforms or to an on-premises infrastructure. The cloud services are migrated without losing the operational metadata associated with the cloud services. In the process, the multi-cloud deployment engine also allows users to choose different cloud resources from different cloud vendors for deploying a set of cloud services, thereby facilitating the users in deploying a true multi-cloud or hybrid cloud architecture. Additionally, the multi-cloud deployment engine also helps users in seamlessly moving services from an on-premises deployment to one or more cloud computing platforms.

The multi-cloud deployment engine provides a user interface that is used to receive service requests from users. In some embodiments, a service request includes a request for deploying new services, migrating already deployed services, acquiring current details of the deployed services, or to compare different deployments or services of different cloud vendors hosting cloud computing platforms (e.g., a cost and/or performance comparison). The user interface allows users to input requirements of a service into the multi-cloud deployment engine (e.g., how much compute, memory, and storage is to be allocated to a service; whether a load balancer is to be provided for the service; etc.). Additionally, the user interface is used to provide various notifications to the users. One such notification is a confirmation notification to a user that a request to deploy a service to a cloud computing platform is successful. In some embodiments, the multi-cloud deployment engine provides an application programming interface (API) in a cloud context such that the multi-cloud deployment engine (e.g., hosted within a cloud environment) can be accessed through the API such as for migrating and deploying services and/or for interacting with cloud computing platforms and on-premises computing devices.

The multi-cloud deployment engine is configured with functionality that can interpret service requests of the users, and with functionality for deploying the services using cloud resources available through one or more cloud computing platforms. The multi-cloud deployment engine provides access to multiple cloud resources from multiple cloud vendors. Additionally, the multi-cloud deployment engine provides access to resources used to deploy services to an on-premises infrastructure.

In some embodiments, a user submits a service request through the user interface. The service request specifies that “2 compute instances connected to 1 LB” are to be deployed (e.g., a service is to be deployed across 2 compute instances that are connected to 1 load balancer). In response to receiving the service request, the multi-cloud deployment engine translates (converts) the service request into a corresponding deployment script that is specifically formatted according to programming semantics of a target cloud computing platform for hosting the service. Further, the multi-cloud deployment engine identifies one or more cloud resources, among the available pool of resources, which can be used for the deployment requested by the service request. The one or more cloud resources may be hosted by a single cloud computing platform or hosted by multiple different cloud computing platforms. The multi-cloud deployment engine optimally selects the cloud computing platform(s) (e.g., cloud resources and cloud vendors) based on parameters such as cost of deployment, reliability, availability, security, redundancy, storage efficiency, performance (e.g., speed of operation), etc. provided by the cloud computing platforms. For example, the multi-cloud deployment engine may select a first cloud computing platform to host a first component of the service (e.g., cloud formation), a second cloud computing platform to host a second component of the service (e.g., a resource manager), and a third cloud computing platform to host a third component of the service (e.g., a deployment manager).

Once the cloud computing platform(s) are selected, the multi-cloud deployment engine deploys the service on the selected cloud computing platforms (cloud resource and vendors), and provides a confirmation to the user. For example, the confirmation may include reasons for selecting a specific set of cloud resources/vendors for deploying the requested service, benefits of utilizing such a deployment arrangement, etc. Thus, the multi-cloud deployment engine ensures that the user benefits from a true multi-cloud or hybrid cloud architecture (e.g., in terms of a cost comparison of the service costs of different cloud vendors for hosting the service). The multi-cloud deployment engine utilizes a similar process when the user requests to move or migrate the service from one cloud computing platform to a different cloud computing platform or to an on-premised infrastructure.

In some embodiments, the multi-cloud deployment engine receives a service request such as through the user interface associated with the multi-cloud deployment engine. The service request may be formatted according to a human readable format/language. For example, the service request can be a generic service request with text such as “Create a Virtual Machine.” After receiving the service request, the multi-cloud deployment engine translates the service request into a corresponding deployment script. The deployment script is formatted according to a machine readable format such as a cloud creation script. Subsequently, the multi-cloud deployment engine selects one or more cloud computing platforms (cloud vendors) that can be used to optimally build the service. The multi-cloud deployment engine may select a single cloud computing platform or a combination of multiple cloud computing platforms. In some embodiments, the multi-cloud deployment engine selects the combination of multiple cloud computing platforms such as where the combination can be used to build a cost-effective cloud architecture for hosting the service.

In some embodiments, a service is already deployed on a given cloud computing platform, and the service is to be migrated or moved to a different cloud computing platform (a different cloud vendor) or to an on-premises infrastructure. The multi-cloud deployment engine obtains a cloud deployment script corresponding to the service that is currently deployed on the cloud computing platform. The cloud deployment script is formatted according to the machine readable format/script specified to the cloud computing platform (a vendor specific deployment script).

Subsequently, the cloud deployment script (the vendor specific deployment script) is converted or translated into a corresponding human readable format or script a vendor neutral script) and is provided to a user. The human readable script may be used to deploy the service on a different cloud computing platform (a different cloud vendor) by translating the human readable into a vendor specific deployment script formatted according to programming semantics of the different cloud computing platform. In this way, the vendor specific deployment script is used to migrate the service.

Various embodiments of the present technology provide for a wide range of technical effects, advantages, and/or improvements to computing systems and components. For example, various embodiments may include one or more of the following technical effects, advantages, and/or improvements: 1) the multi-cloud deployment engine provides multi-cloud deployment where services can be deployed utilizing resources of multiple different cloud computing platforms (multiple cloud vendors) without being locked into any single cloud vendor; 2) the multi-cloud deployment engine provides seamless cloud-to-cloud migration of services between different cloud computing platforms, cloud-to-on premises migration to migrate a service from a cloud computing platform to on-premises, and seamless on-premises-to-cloud migration with little to no downtime; 3) the multi-cloud deployment engine optimizes deployment costs by generate real-time recommendations for what services (e.g., non-essential services) can be removed (opted out) from deployment or migration of a set of services from one cloud computing platform to another cloud computing platform in order to conserve compute and storage resources otherwise wasted in host such services, thus reducing the cost of deployment and migration of services; 4) the multi-cloud deployment engine generates and provides custom deployment plans based upon cost comparisons of services across different cloud computing platforms (different cloud vendors) in order to optimize deployment costs); and 5) the multi-cloud deployment engine is custom configured to translate/reformat between service requests and service representations formatted according to a human readable format or cloud provider neutral format to deployment scripts having a machine readable format that is formatted according to programming semantics supported by a particular cloud computing platform for deploying/migrating services to that cloud computing platform.

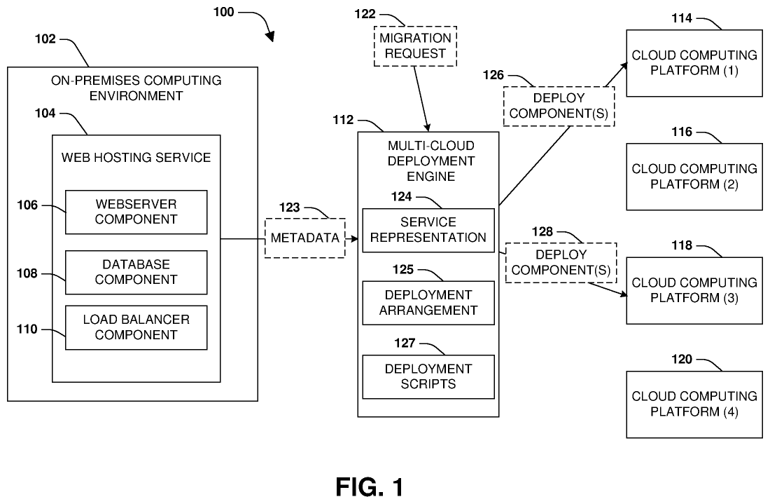

FIG. 1 is a block diagram illustrating an embodiment of a system 100 for deploying components of a service across one or more cloud computing platforms in order to migrate the service. The service such as a web hosting service 104 is hosted within an on-premises computing environment 102. The on-premises computing environment 102 may include computing resources (e.g., storage resources, servers, virtual machines, compute resources, memory resources, etc.) that are maintained or managed by a provider of the web hosting service 104. The web hosting service 104 includes various components such as a webserver component 106 that hosts a website provided by the web hosting service 104, a database component 108 that stores website data of the website, and a load balancer component 110 that directs/redirects incoming client requests to compute instances configured to process incoming client requests for the website.

A multi-cloud deployment engine 112 is capable of deploying and migrating services between the on-premises computing environment 102 and various cloud computing platforms (e.g., cloud resources of different cloud providers). The multi-cloud deployment engine 112 may be hosted on-premises, at a server such as a remote server, within a cloud computing environment, or at any other computing device or service. The multi-cloud deployment engine 112 may receive a migration request 122 to migrate the web hosting service 104. In some embodiments, the migration request 122 may be received through a user interface from a user. In some embodiments, the migration request 122 may specify that the web hosting service 104 is to be migrated to a particular cloud computing platform or set of cloud computing platforms. In some embodiments, the migration request 122 merely specifies that the web hosting service 104 is to be migrated, and thus the multi-cloud deployment engine 112 will execute logic (e.g., cost optimization logic, performance optimization logic, etc.) to select certain cloud computing platform(s) as migration targets for the web hosting service 104.

The migration request 122 may specify a current deployment location of the web hosting service 104 and how to access data and metadata (operational metadata) of the webserver component 106, the database component 108, and the load balancer component 110 of the web hosting service 104. Accordingly, the multi-cloud deployment engine 112 obtains metadata 123 of the web hosting service 104. The metadata 123 may describe functionality, commands, properties, resources, and operation of the web hosting service 104, the webserver component 106, the database component 108, and/or the load balancer component 110. In some embodiments, the metadata 123 may describe an IP address, a name of a load balancer, a scheme of the load balancer, security groups, subnet mappings, tags, a resource name, a resource type, a resource location, tags of a resource, port and connectivity information of a backend service, etc. The multi-cloud deployment engine 112 translates the metadata 123 of the web hosting service 104 into a service representation 124 having a cloud provider neutral format. In some embodiments, service representation 124 may describe how to deploy the web hosting service 104 and/or comprise script or other functionality to generally deploy the web hosting service 104, but is not formatted to a specific format of a particular cloud computing platform.

The service representation 124 may comprise deployment parameters that can be used to deploy the web hosting service 104 (e.g., an IP address of a component, a name of the component, a scheme used by the component, security groups, subnet mappings, tags, a resource name, a resource type, a resource location, tags of a resource, port and connectivity information, etc.). The deployment parameters may be defined according to the cloud provider neutral format. In some embodiments of determining the deployment parameters for a service, the service may be hosted as a virtual machine. An application programming interface of a hypervisor hosting the virtual machine may be utilized to obtain the metadata 123. The metadata 123 may be evaluated to determine how the virtual machine is running on-premises at the on-premises computing environment 102 through the hypervisor. The deployment parameters may be determined based upon how the virtual machine is running on-premises.

The multi-cloud deployment engine 112 utilizes the deployment parameters and characteristics of cloud computing platforms such a first cloud computing platform 114, a second cloud computing platform 116, a third cloud computing platform 118, and a fourth cloud computing platform 120 to select a deployment arrangement 125 of one or more cloud computing platforms for hosting the components of the web hosting service 104. The characteristics of the cloud computing platform may include resiliency, availability, network access, pay-per-use pricing, resource pooling, scalability and rapid elasticity, on-demand self-service, various costs, performance, etc. Similarly, the deployment parameters may relate to or be indicative of performance, resource availability, resiliency, and/or other characteristics of the cloud computing platforms. Thus, the deployment arrangement 125 may include select cloud computing platforms that may satisfy the deployment parameters so that the web hosting service 104 will operate at a certain performance level with an optimized cost (e.g., an optimal or lowest cost that still satisfy performance requirements of the web hosting service 104). In some embodiments, the deployment arrangement 125 specifies that the database component 108 is to be hosted by the first cloud computing platform 114 and that the webserver component 106 and the load balancer component 110 are to be hosted by the third cloud computing platform 118. The deployment arrangement 125 may provide a lower cost deployment while still satisfying performance requirements, resiliency requirements, availability requirements, security requirements, and/or other requirements of the web hosting service 104 identified by the deployment parameters.

The multi-cloud deployment engine 112 generates deployments scripts 127 that include a deployment script for each of the cloud computing platforms of the deployment arrangement 125 such as a deployment script to deploy 126 the database component 108 to the first cloud computing platform 114 and a deployment script to deploy 128 the webserver component 106 and the load balancer component 110 to the third cloud computing platform 118. In order to generate a deployment script for a cloud computing environment, the multi-cloud deployment engine 112 translates the service representation 124 from the cloud provider neutral format into a deployment script having a machine readable format that is formatted according to programming semantics supported by the cloud computing platform. That is, different cloud computing platforms may support different programming semantics, syntax, commands, inputs, output, programming code, etc. Accordingly, script, programming code, variables, parameters, input, outputs, and/or other data/information within the service representation 124 may be modified to conform to the programming semantics supported by the cloud computing platform to create the deployment script for that cloud computing platform.

In some embodiments, the multi-cloud deployment engine 112 automatically executes the deployment scripts 127 to deploy 126 the database component 108 to the first cloud computing platform 114 and deploy 128 the webserver component 106 and the load balancer component 110 to the third cloud computing platform 118.

In some embodiments, the multi-cloud deployment engine 112 generates and provides a deployment plan through a user interface for a user to select how to migrate the web hosting service 104 to one or more cloud computing platforms. The multi-cloud deployment engine 112 may execute cost optimization logic and/or performance optimization logic to perform a cost and/or performance comparison between hosting the service on-premises and hosting the service across different combinations of cloud computing platforms. The cost and/or performance comparison is performed to generate a ranked list of deployment arrangements that are ranked based upon cost savings in relation to performance. For example, cloud providers may publish costs for certain services, performance, storage, compute, etc., which may be compared with requirements for hosting each different component of the web hosting service 104 is order to determine a desired deployment arrangement. For example, the desired deployment arrangement may be generated based upon a determination that the first cloud computing platform 114 provides the lowest cost storage, and thus the desired deployment arrangement may specify that database component 108 is to be deployed 126 to the first cloud computing platform 114. The third cloud computing platform 118 may provide the lowest cost compute, and thus the desired deployment arrangement may specify that the webserver component 106 and the load balancer component 110 are to be deployed 128 to the third cloud computing platform 118. In this way, a result of the cost comparison may be populated within the deployment plan.

In some embodiments, the deployment parameters, the characteristics of the cloud computing platforms, and the deployment arrangements are utilized to populate the deployment plan with reasons why each deployment arrangement includes certain cloud computing platforms for hosting certain components of the web hosting service 104 and benefits (e.g., improved performance, improved security, improved availability, lower cost, etc.) of using each deployment arrangement such as in relation to the current deployment in the on-premises computing environment 102. In this way, the deployment plan may be displayed through a user interface so that a user can select and/or edit a particular deployment arrangement to utilize for migrating the web hosting service 104.

In some embodiments, the web hosting service 104 is migrated in a seamless manner (e.g., a non-disruptive manner where users are capable of accessing the web hosting service 104 through the on-premises computing environment 102 during the migration).

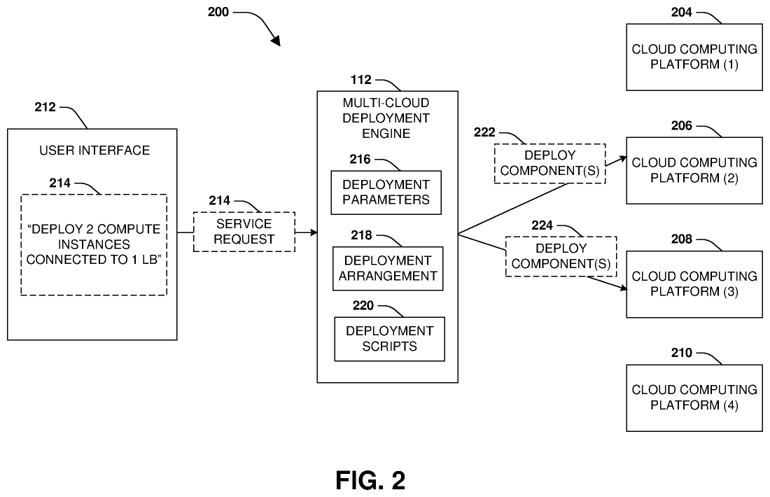

FIG. 2 is a block diagram illustrating an embodiment of a system 200 for deploying components of a service across one or more cloud computing platforms in order to deploy the service. The multi-cloud deployment engine 112 provides or is associated with a user interface 212 through which a user can submit service requests for deploying or migrating services between on-premises and cloud computing platforms. For example, a user may utilize the user interface 212 to input a service request 214 that includes the text “deploy 2 compute instances connected to 1 LB.” The service request 214 may be formatted according to a human readable format. The multi-cloud deployment engine 112 is capable of parsing and understanding what is meant by the text “deploy 2 compute instances connected to 1 LB.” For example, the multi-cloud deployment engine 112 may utilize text parsing functionality, keyword extraction functionality, feature extraction, machine learning models, and/or other information to determine that the text “deploy 2 compute instances connected to 1 LB” means that 2 separate compute instances connected to 1 load balancer for balancing traffic to the 2 compute instances is to be created and deployed to one or more cloud computing platforms (resources of cloud providers). The multi-cloud deployment engine 112 may be capable of determining that a service that includes the 2 compute instances and the 1 load balancer is to be deployed. In this way, the multi-cloud deployment engine 112 is capable of evaluating the service request 214 to determine deployment parameters 216 for deploying the service that includes components such as the 2 compute instances and the 1 load balancer connected to the 2 compute instances.

Depending on the service request 214, the deployment parameters 216 may comprise a variety of different parameters such as storage requirements, compute requirements, memory requirements, database requirements, a type of service, a type of component, security requirements, availability requirements, redundancy requirements, network requirements, naming requirements, etc. In some embodiments, text of the service request 214 is parsed to extract information used to determine the deployment parameters 216. The deployment parameters 216 may include a network configuration for the service, a definition defining how the service is to operate, a load balancer that will be used as part of the service, a database server that will be used as part of the service, a webserver that will be used as part of the service, an amount of compute to allocate to the service, an amount of storage resources to allocate to the service, a virtual machine that will be used as part of the service, etc.

The multi-cloud deployment engine 112 utilizes the deployment parameters 216 to evaluate characteristics of available cloud computing platforms such a first cloud computing platform 204, a second cloud computing platform 206, a third cloud computing platform 208, and a fourth cloud computing platform 210 to select a deployment arrangement 218 of one or more cloud computing platforms for hosting the components of the service such as the 2 compute instances and the load balancer. The characteristics of the cloud computing platform may include resiliency, availability, network access, pay-per-use pricing, resource pooling, scalability and rapid elasticity, on-demand self-service, various costs, performance, etc. The deployment parameters may relate to performance, resource availability, resiliency, resources to allocate, compute to host, and/or other characteristics or services provided by the cloud computing platforms. Accordingly, the deployment arrangement 218 may include select cloud computing platforms that may satisfy the deployment parameters 216 so that the web hosting service will operate at a certain performance level with an optimized cost (e.g., an optimal or lowest cost that still satisfy performance requirements of the service).

In some embodiments, the deployment arrangement 218 specifies that a first compute instance component is to be hosted by the second cloud computing platform 206 and that a second compute instance component and a load balancer component are to be hosted by the third cloud computing platform 208. The deployment arrangement 218 may provide a lower cost deployment while still satisfying performance requirements, resiliency requirements, availability requirements, security requirements, and/or other requirements of the service identified by the deployment parameters. For example, the first compute instance and the second compute instance may be hosted at different cloud computing platforms to improve resiliency in the event one of the cloud computing platforms has a failure.

The multi-cloud deployment engine 112 generates deployment scripts 220 that include a deployment script for each of the cloud computing platforms of the deployment arrangement 218. The multi-cloud deployment engine 112 is configured with script generating functions capable of generating script (e.g., programming code) that is formatted according to programming semantics of various cloud computing platforms. The script generating functions may take a service request (e.g., “deploy a text-to-speech service”) or service representation of the service as input, and reformats the input into a script formatted according to programming semantics of a cloud computing platform so that the cloud computing platform can use the script to deploy and host the service.

The deployment scripts 220 include a deployment script to deploy 222 the first compute instance component to the second cloud computing platform 206 and a deployment script to deploy 224 the second compute instance and the load balancer component to the third cloud computing platform 208. In order to generate a deployment script for a cloud computing environment, the multi-cloud deployment engine 112 translates the service request from the human readable format into a deployment script having a machine readable format that is formatted according to programming semantics supported by the cloud computing platform. That is, different cloud computing platforms may support different programming semantics, syntax, commands, inputs, output, programming code, etc. Accordingly, script, programming code, variables, parameters, input, outputs, and/or other data/information may be generated from the service request 214 to create the deployment script that conforms to the programming semantics supported by the cloud computing platform.

In some embodiments where a cloud computing environment is to be formed for the service, a cloud formation deployment script is generated. The cloud formation deployment script is formatted according to programming semantics of a cloud computing platform where the cloud computing environment is to be formed. In this way, the cloud formation deployment script is executed to perform cloud formation through the cloud computing environment for the service.

In some embodiments where a resource manager is to be used for the service, a resource manager deployment script is generated. The resource manager deployment script is formatted according to programming semantics of a cloud computing platform where the resource manager is to be hosted. In this way, the resource manager deployment script is executed to host the resource manager through the cloud computing environment for the service.

In some embodiments where a deployment manager is to be used for the service, a deployment manager deployment script is generated. The deployment manager deployment script is formatted according to programming semantics of a cloud computing platform where the deployment manager is to be hosted. In this way, the deployment manager deployment script is executed to host the deployment manager through the cloud computing environment for the service.

In this way, a component of a service may be deployed as a particular type of resource/service tailored for a particular type of cloud computing platform.

In some embodiments, the multi-cloud deployment engine 112 automatically executes the deployment scripts 220 to deploy 222 the first compute instance component to the second cloud computing platform 206 and deploy 224 the second compute instance component and the load balancer component to the third cloud computing platform 208.

In some embodiments, the multi-cloud deployment engine 112 generates and provides a deployment plan through a user interface for a user to select how to deploy the service to one or more cloud computing platforms. The multi-cloud deployment engine 112 may execute cost optimization logic and/or performance optimization logic to perform a cost and/or performance comparison between hosting the service across different combinations of cloud computing platforms. The cost and/or performance comparison is performed to generate a ranked list of deployment arrangements that are ranked based upon cost savings in relation to performance. For example, cloud providers may publish costs for certain services, performance, storage, compute, etc., which may be compared with requirements for hosting each different component of the service is order to determine a desired deployment arrangement. In this way, a result of the cost comparison may be populated within the deployment plan. In some embodiments, the deployment parameters, the characteristics of the cloud computing platforms, and the deployment arrangements are utilized to populate the deployment plan with reasons why each deployment arrangement includes certain cloud computing platforms for hosting certain components of the service and benefits (e.g., improved performance, improved security, improved availability, lower cost, etc.) of using each deployment arrangement. The deployment plan may be displayed through a user interface so that a user can select and/or edit a particular deployment arrangement to utilize for migrating the web hosting service 104. In this way, the service is deployed across one or more of the cloud computing platforms.

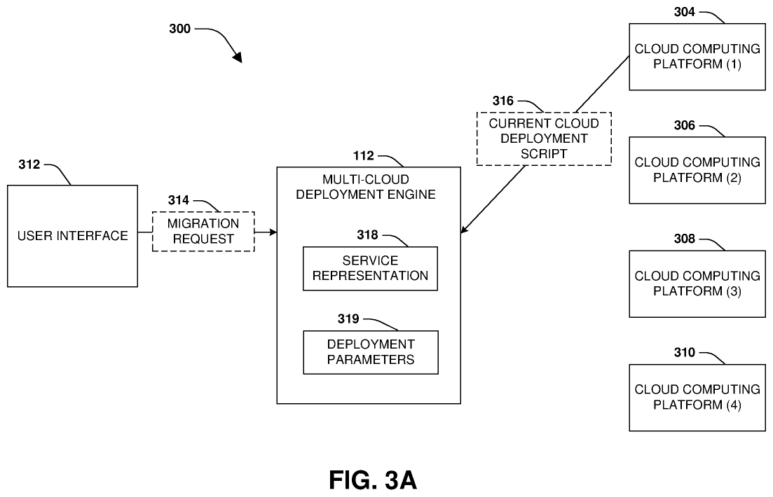

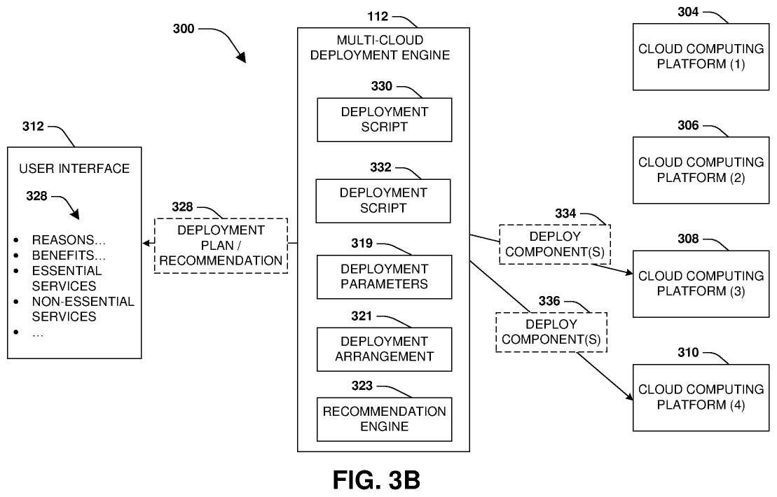

FIG. 3A is a block diagram illustrating an embodiment of a system 300 for obtaining a current cloud deployment script 316 of a service to migrate, and FIG. 3B is a block diagram illustrating an embodiment of the system 300 providing a deployment plan 328 and recommendation for migrating the service. The service may currently be hosted within a first cloud computing platform 304 using resources of a cloud provider of the first cloud computing platform 304. The multi-cloud deployment engine 112 may monitor or obtain metrics associated with the service being hosted by the first cloud computing platform 304. The metrics may relate to a total cost charged for hosting the service over a particular time period (e.g., a service provider of the service may provide this information to the multi-cloud deployment engine 112). The metrics may relate to performance of the service, where the service provider of the first cloud computing platform 304 may provide this information to the multi-cloud deployment engine 112, or the multi-cloud deployment engine 112 may access the service in order to test and collect such performance metrics. In some embodiments, the multi-cloud deployment engine 112 may provide this information to the service provider. Using the previously described techniques, the multi-cloud deployment engine 112 may also compare deployment parameters of the service to characteristics of other cloud computing platforms in order to identify deployment arrangements of different cloud computing platform(s) that could provide improved performance, reduced cost, higher availability, etc. The multi-cloud deployment engine 112 may also provide the deployment arrangements to the service provider.

The multi-cloud deployment engine 112 may receive a migration request 314 from the service provider such as through the user interface 312. In response to receiving the migration request 314, the multi-cloud deployment engine 112 obtains the current cloud deployment script 316 from the first cloud computing platform 304. The current cloud deployment script 316 pertains to how the service is deployed and hosted by the first cloud computing platform 304, and may be formatted according to a proprietary format (programming semantics-specific syntax, commands, functions, inputs, outputs, API calls, etc.) specific to the first cloud computing platform 304. The multi-cloud deployment engine 112 translates the current cloud deployment script 316 from the proprietary format of the first cloud computing platform 304 into a service representation 318 having a cloud provider neutral format that can be used or retranslated into a format for migrating the service to a different cloud computing platform. In some embodiments, the multi-cloud deployment engine 112 parses the current cloud deployment script 316 to identify the deployment parameters 319 of the service representation 318. The deployment parameters 319 may include a network configuration for the service, a definition defining how the service is to operate, a load balancer that will be used as part of the service, a database server that will be used as part of the service, a webserver that will be used as part of the service, an amount of compute to allocate to the service, an amount of storage resource to allocate to the service, a virtual machine that will be used as part of the service, network configuration information, names, tags, etc. The deployment parameters 319 may comprise a variety of different parameters such as storage requirements, compute requirements, memory requirements, database requirements, a type of service, a type of component, security requirements, availability requirements, redundancy requirements, network requirements, naming requirements, etc.

The multi-cloud deployment engine 112 utilizes the deployment parameters 319 of the service representation 318 to evaluate characteristics of available cloud computing platforms such as the first cloud computing platform 304, a second cloud computing platform 306, a third cloud computing platform 308, and a fourth cloud computing platform 310 to create/select a deployment arrangement 321 of one or more cloud computing platforms for hosting components of the service to be migrated from the first cloud computing platform 304, as illustrated by FIG. 3B. The characteristics of the cloud computing platform may include resiliency, availability, network access, pay-per-use pricing, resource pooling, scalability and rapid elasticity, on-demand self-service, various costs, performance, etc. The deployment parameters 321 may relate to performance, resource availability, resiliency, resources to allocate, compute to host, and/or other characteristics or services that can be provided by the cloud computing platforms. The characteristics of the potential arrangements of cloud computing platforms may be compared with current metrics of hosting the service at the first cloud computing platform 304 (e.g., cost and performance metrics) in order to determine whether any potential deployment arrangements provide improved performance, lower cost, improved security, improved availability, or other benefits for the service provider of the service if the service was migrated from the first cloud computing platform 304. In this way, the deployment arrangement 321 may include select cloud computing platforms that may satisfy the deployment parameters 319 so that migrating the service from the first cloud computing platform 304 to cloud computing platforms of the deployment arrangement 321 will provide some benefit such as cost, performance, etc.

In some embodiments, the deployment arrangement 321 specifies that one or more components of the service are to be migrate and deployed 334 to the third cloud computing platform 308 and that one or more other components of the service are to be migrated and deployed 336 to the fourth cloud computing platform 310. The deployment arrangement 321 may provide a lower cost deployment while still satisfying performance requirements, resiliency requirements, availability requirements, security requirements, and/or other requirements of the service identified by the deployment parameters. For example, the first compute instance and the second compute instance may be hosted at different cloud computing platforms to improve resiliency in the event one of the cloud computing platforms has a failure. In some embodiments, one or more of the components may remain at the first cloud computing platform 304, while other components are deployed to other cloud computing platforms.

The multi-cloud deployment engine 112 generates deployments scripts for each of the cloud computing platforms of the deployment arrangement 321 such as a deployment script 330 to migrate and deploy 334 the one or more components of the service to the third cloud computing platform 308 and a deployment script 332 to migrate and deploy 336 the one or more other components of the service to the fourth cloud computing platform 310. In order to generate a deployment script for a cloud computing environment, the multi-cloud deployment engine 112 translates the service representation 318 from the cloud provider neutral format to a deployment script having a machine readable format that is formatted according to programming semantics supported by the cloud computing platform. That is, different cloud computing platforms may support different programming semantics, syntax, commands, inputs, output, programming code, etc. Accordingly, script, programming code, variables, parameters, input, outputs, and/or other data/information may be generated from the service representation 318 to create the deployment script that conforms to the programming semantics supported by the cloud computing platform.

The multi-cloud deployment engine 112 executes the deployment script 330 to migrate and deploy 334 the one or more components of the service to the third cloud computing platform 308. The multi-cloud deployment engine 112 executes the deployment script 332 to migrate and deploy 336 the one or more other components of the service to the fourth cloud computing platform 310. The deployment scripts may be executed to migrate operational metadata of the service from the first cloud computing platform 304 to the third cloud computing platform 308 and the fourth cloud computing platform 310 in a seamless manner (e.g., a non-disruptive manner where users may be capable of accessing the service through the first cloud computing platform 304 during the migration).

In some embodiments, the multi-cloud deployment engine 112 may generate a set of deployment arrangements that each include a different combination of cloud computing platforms for hosting the components of the service. The multi-cloud deployment engine 112 may rank the deployment arrangements based upon various criteria such as cost of hosting the components of the service, performance that will be provided to the service, security, redundancy, encryption or other features, compression (storage savings), availability, etc. In this way, a ranked set of deployment arrangements may be provided through a user interface 312 so that a user can selected a particular deployment arrangement to utilize for migrating the service from the first cloud computing platform 304. The user interface 312 may be populated with various information such as cost and performance metrics for each deployment (e.g., a projected monthly cost, IOPS, bandwidth, latency, resource allocations, etc.).

The user interface 312 may be populated with the service description. The multi-cloud deployment engine 112 may generate the service description by formatting the service representation 318 into a human readable format. In this way, a user can understand resource requirements of the service, components used to host the service, network requirements of the service, and/or other descriptive content describing operation of the service or how to host the service.

In some embodiments, a deployment plan 328 describing a recommendation of the deployment arrangement 321 may be generated and provided through the user interface 312. The recommendation may provide reasons why the deployment arrangement 321 was selected (e.g., the fourth cloud computing platform 310 can host a component of the service at a lower cost than the first cloud computing platform 304, the third cloud computing platform 308 will provide improved performance for a different component of the service, etc.). The deployment plan 328 may be populated with benefits, such as cost benefits, performance benefits, security benefits, availability benefits (e.g., continued service in the event of a failure), redundancy benefits, and/or other benefits of utilizing the deployment arrangement 321. The deployment plan 328 may be populated with a description of essential services (if a set of services are to be migrated) or components of the service that must be available for proper operation. The deployment plan 328 may be populated with a description of non-essential services (if a set of services are to be migrated) or components of the service that can be opted out from being migrated. In this way, the user may select certain services and/or components for migration.

In some embodiments, a recommendation engine 323 is implemented to recommend services such as a set of services to migrate based upon a cost of hosting the services within certain cloud computing platforms. The recommendation engine 323 may periodically, or based upon receiving a request, evaluate the current cost and/or performance of services deployed on-premises and/or within cloud computing platforms. The recommendation engine 323 may comprise the current cost and performance with a cost and/or performance associated with hosting the services at other cloud computing platforms in order to generate a recommendation of services to migrate for reduce deployment/hosting costs.

In some embodiments, a migration request may specify a set of services to migrate. Current cloud deployment scripts of the set of services may be obtained and translated to create a set of service representations. The set of service representations are evaluated to identify any services that can be opted out from being migrated based upon the services being identified as non-essential services (e.g., a chat bot service that is currently not being used, a deduplication service that is no longer being used, a website feature no longer being used, functionality no longer being used, etc.). A recommendation of the deployment arrangement 321 that excludes the non-essential services may be generated and provided through the user interface 312. In this way, the recommendation may be provided through the user interface 312 so that a user may select certain services and/or components to migrate.

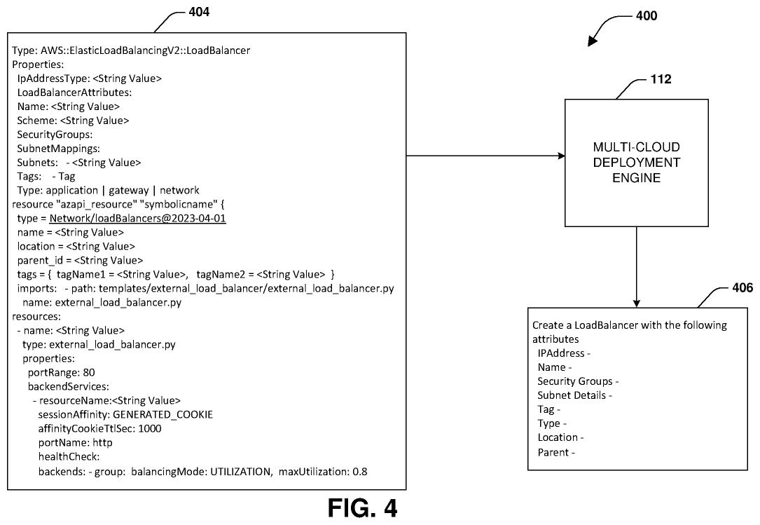

FIG. 4 is a block diagram illustrating an embodiment of a system 400 for translating a current cloud deployment script 404 into a service representation 406. The current cloud deployment script 404 may be used as part of deploying a service (or a component of a service) on a cloud computing platform. For example, the current cloud deployment script 404 may be used by a cloud computing platform to host a load balancer component of a service. The current cloud deployment script 404 may specify properties of the load balancer component such as an IP address type, load balancer attributes, a name, a scheme, security groups, subnet mappings, subnets, tags, type (e.g., application, gateway, network, etc.). The current cloud deployment script 404 may specify a first set of resource information such as type, name, location, parent ID, tags, imports such as path and name, etc. The current cloud deployment script 404 may specify a second set of resource information such as name, type, and properties such as port range, backend services with resource name, session affinity cookie, port name, health check, and backends that include group, balancing mode, and max utilization. The multi-cloud deployment engine 112 is capable of converting the current cloud deployment script 404 from a proprietary format, used by the cloud computing platform for hosting the load balancer component, to a format such as either a human readable format or a cloud provider neutral format as the service representation 406. The service representation 406 may describe attributes of the load balancer such as IP address, name, security groups, subnet details, tag, type location, and parent. In this way, the service representation 406 may be displayed through a user interface to a user, or may be converted into a deployment script having a cloud provider specific format for deploying/migrating the load balancer to a particular cloud computing platform.

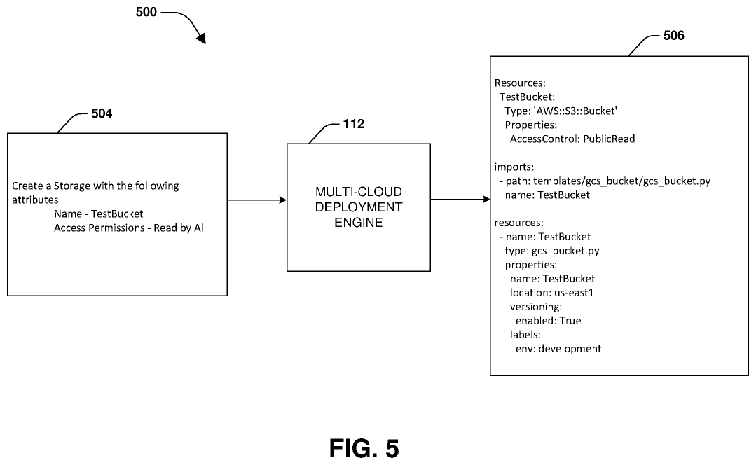

FIG. 5 is a block diagram illustrating an embodiment of a system 500 for translating a service request 504 into a deployment script 506. The multi-cloud deployment engine 112 may receive the service request 504, which may be input by a user through a user interface according to a human readable format. The service request 504 may specify “Create a Storage with the following attributes Name—Testbucket Access Permissions—Read by All.” The multi-cloud deployment engine 112 translates the service request 504 into a deployment script 506 that can be used to deploy the service through a cloud computing platform. The deployment script 506 may include script formatted according to a cloud computing format of the cloud computing platform (e.g., a machine readable format specific to the cloud computing platform such as a cloud computing platform) that adheres to programming semantics of the cloud computing format. The deployment script 506 may specify resources such as a TestBucket to create, which has a certain type and properties such as access control properties. The deployment script 506 may specify imports such as a path and name for the TestBucket. The deployment script 506 may specify resources such as a name, type, and properties that include name, location, versioning, and labels. In this way, the deployment script 506 can be executed to create the storage within the cloud computing platform.

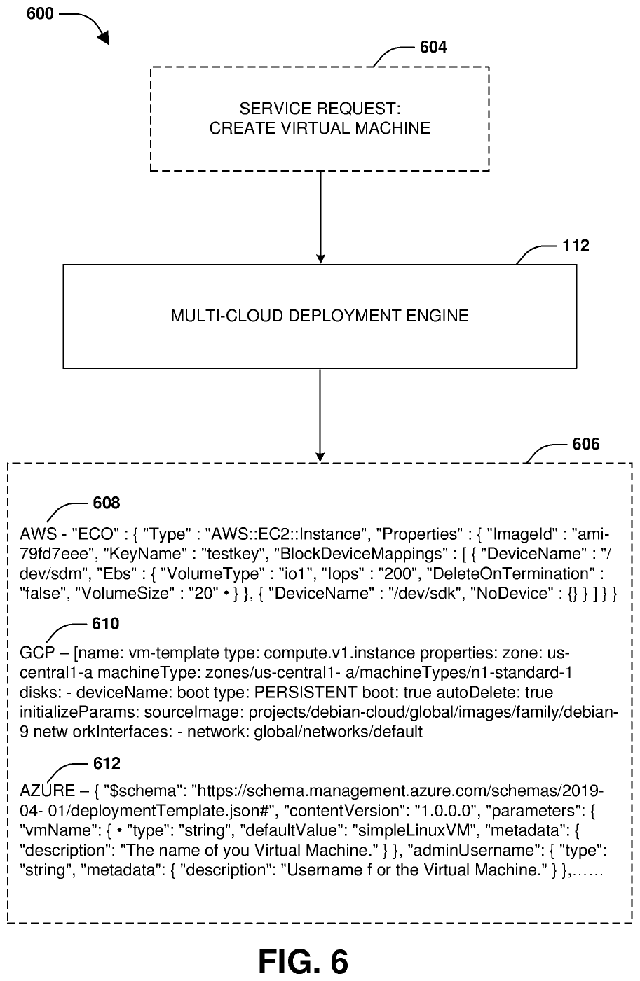

FIG. 6 is a block diagram illustrating an embodiment of a system 600 for translating a service request 604 into a service representation 606 having a cloud provider neutral format. The multi-cloud deployment engine 112 may receive the service request 604, which may be input by a user through a user interface according to a human readable format. The service request 604 may specify “create virtual machine.” The multi-cloud deployment engine 112 transforms the service request 604 from the human readable format to the service representation 606 having the cloud provider neutral format. The service representation 606 may comprise a first representation 608 of how to deploy a first component of a service to a first cloud computing platform. The service representation 606 may comprise a second representation 610 of how to deploy a second component of the service to a second cloud computing platform. The service representation 606 may comprise a third representation 612 of how to deploy a third component of the service to a third cloud computing platform. In this way, the service representation 606 can be used to generate deployment scripts for each of the cloud computing platforms for deploying the components of the service to the corresponding cloud computing platforms. Each deployment script may be formatted according to programming semantics specific to a corresponding cloud computing platform.

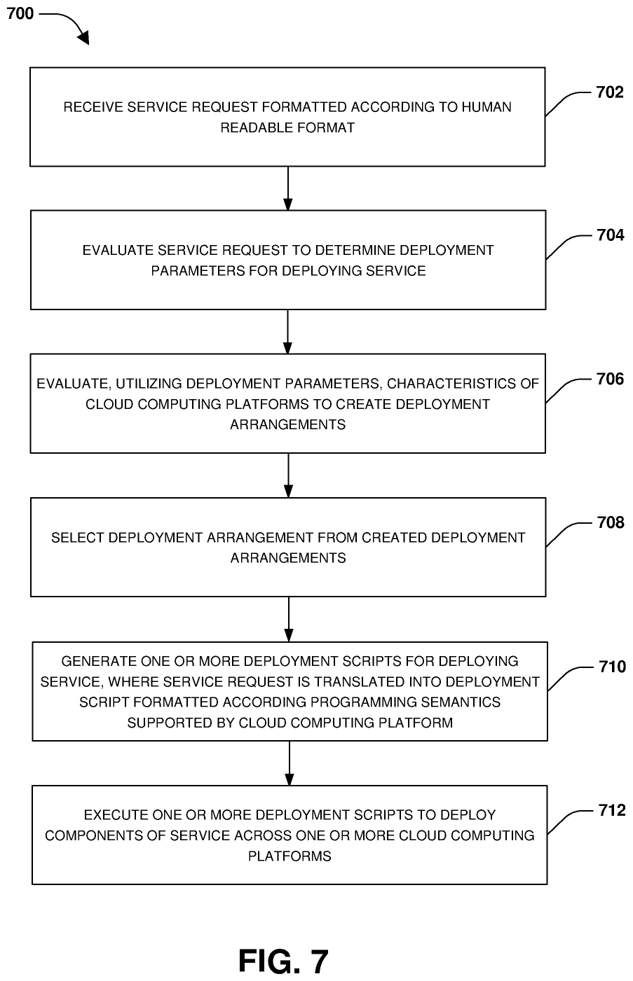

FIG. 7 is a flow chart illustrating an embodiment of a method 700 for deploying components of a service across one or more cloud computing platforms. During operation 702 of method 700, a service request is received such as by the multi-cloud deployment engine 112. The service request may be formatted according to a human readable format such as where a user inputs text into a user interface to generate the service request. The service request may describe a service that the user is requesting to deploy, such as “deploy Text to Speech service,” which could be deployed as different types of services within different cloud computing platforms (e.g., a first cloud computing platform may provide a first type of text to speech service tailored for the first cloud computing platform; a second cloud computing platform may provide a second type of text to speech service tailored for a second cloud computing platform; etc.).

During operation 704 of method 700, the service request is evaluated by the multi-cloud deployment engine to determine deployment parameters for deploying the service. The deployment parameters may relate to a compute instance component to deploy for processing requests of the Text to Speech service, a database component with storage, and/or other components of the service. The deployment parameters may specify parameters of resources, import information, a resource name, a resource type, a resource location for deploying the resource, whether versioning should be enabled, an IP address of a component, a name of the component, a scheme used by the component, security groups, subnet mappings, tags, tags of a resource, port and connectivity information, etc.

During operation 706 of method 700, the multi-cloud deployment engine utilizes the deployment parameters to evaluate characteristics of cloud computing platforms to create deployment arrangements of different combinations of cloud computing platforms. Each deployment arrangement may include one or more cloud computing platforms used to host components of the service such as the compute instance component, the database component, and/or other components. Each cloud computing platform may provide a certain amount of performance, security, storage efficiency, bandwidth, availability, and/or other characteristics/services at a particular cost, which can be used to rank and compare the different deployment arrangements according to a cost/benefit analysis. During operation 708 of method 700, the deployment arrangements are evaluated to identify a deployment arrangement that may provide a required benefit (e.g., performance, security, storage efficiency, bandwidth, availability, etc.) at a target cost (e.g., a lowest cost).

During operation 710 of method 700, one or more deployment scripts are generated for deploying the service. In order to generate a deployment script to deploy a component of the service to a particular cloud computing platform, the service request is translated into a deployment script formatted according to programming semantics supported by the cloud computing platform. During operation 712 of method 700, the deployment scripts are executed to deploy components of the service across the one or more cloud computing platforms specified by the deployment arrangement selected during operation 708.

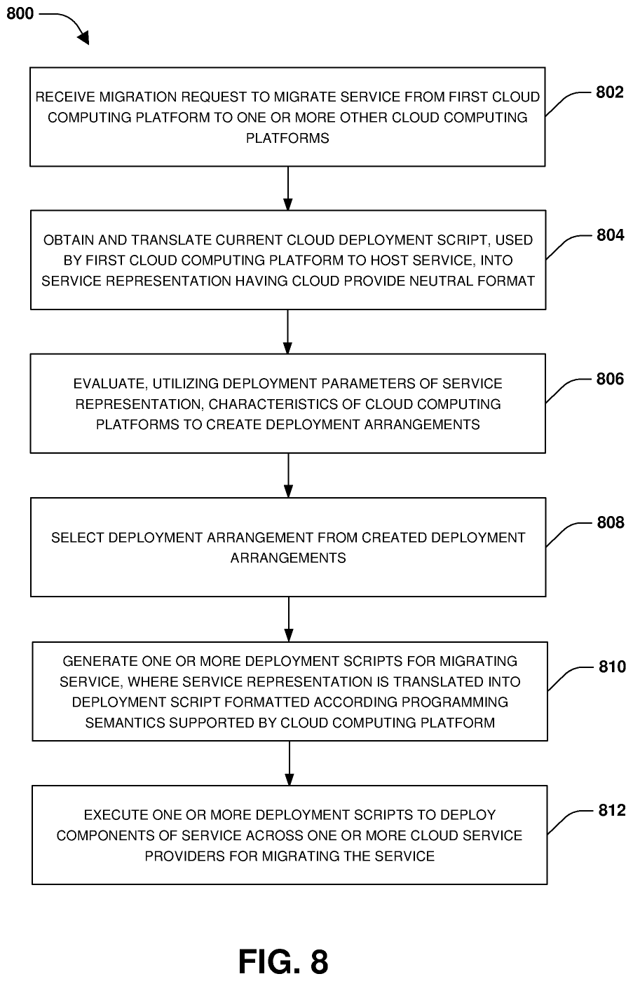

FIG. 8 is a flow chart illustrating an embodiment of a method 800 for deploying components of a service across one or more cloud computing platforms. During operation 802 of method 800, a migration request is received such as by the multi-cloud deployment engine 112. The migration request may identify a particular service that is hosted within a cloud computing platform(s), and may include credentials that can be used by the multi-cloud deployment engine 112 to obtain access to the service (or the credentials may be maintained at or retrieved by the multi-cloud deployment engine 112).

During operation 804 of method 800, a current cloud deployment script used by the cloud computing platform for deployment of the service is retrieved from the cloud computing platform such as by utilizing the credentials. The current cloud deployment script may be translated from a machine readable format (e.g., a proprietary format conforming to programming semantics of the cloud computing platform) into a service representation having a cloud provider neutral format. The service representation may comprise deployment parameters, in the cloud provider neutral format, for deploying the service. During operation 806 of method 800, the deployment parameters of the service representation are used to evaluate characteristics of cloud computing platforms to create deployment arrangements of different combinations of cloud computing platforms. Each deployment arrangement may include one or more cloud computing platforms used to host components of the service such as the compute instance component, the database component, and/or other components. Each cloud computing platform may provide a certain amount of performance, security, storage efficiency, bandwidth, availability, and/or other characteristics/services at a particular cost, which can be used to rank and compare the different deployment arrangements according to a cost/benefit analysis. During operation 808 of method 800, the deployment arrangements are evaluated to identify a deployment arrangement that may provide a required benefit (e.g., performance, security, storage efficiency, bandwidth, availability, etc.) at a target cost (e.g., a lowest cost).

During operation 810 of method 800, one or more deployment scripts are generated for deploying the service. In order to generate a deployment script to deploy a component of the service to a particular cloud computing platform, the service representation is translated from the cloud provider neutral format into a deployment script formatted according to programming semantics supported by the cloud computing platform. During operation 812 of method 800, the deployment scripts are executed to deploy components of the service across the one or more cloud computing platforms specified by the deployment arrangement selected during operation 808.

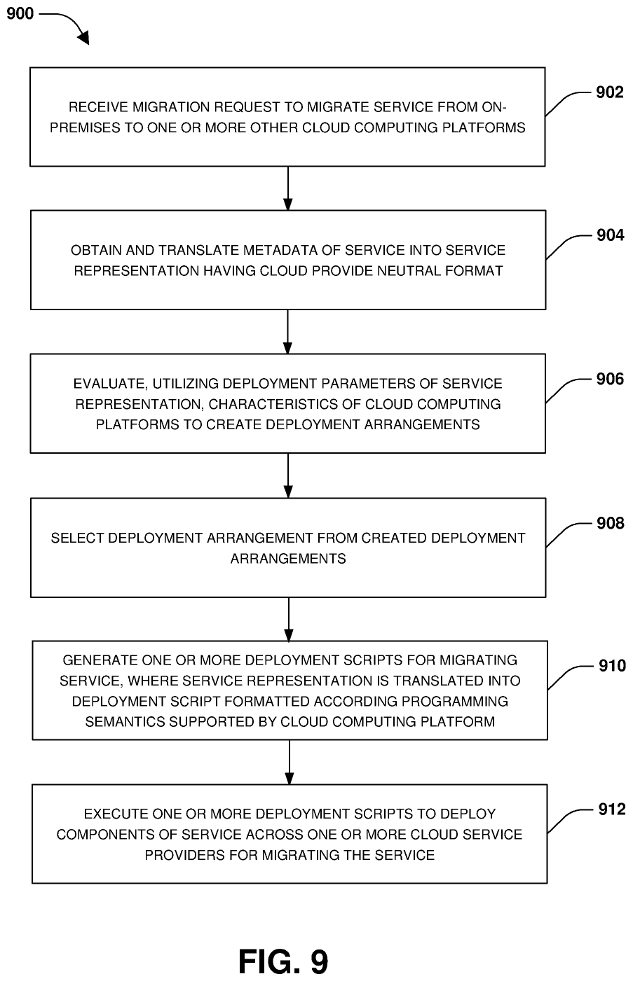

FIG. 9 is a flow chart illustrating an embodiment of a method 900 for deploying components of a service across one or more cloud computing platforms. During operation 902 of method 900, a migration request is received such as by the multi-cloud deployment engine 112. The migration request may identify a particular service that is hosted on-premises. During operation 904 of method 900, metadata (operational metadata) of the service is retrieved such as from a hypervisor hosting a virtual machine running the service. The metadata may be translated into a service representation having a cloud provider neutral format. The service representation may comprise deployment parameters, in the cloud provider neutral format, for deploying the service.

During operation 906 of method 900, the deployment parameters of the service representation are used to evaluate characteristics of cloud computing platforms to create deployment arrangements of different combinations of cloud computing platforms. Each deployment arrangement may include one or more cloud computing platforms used to host components of the service such as the compute instance component, the database component, and/or other components. Each cloud computing platform may provide a certain amount of performance, security, storage efficiency, bandwidth, availability, and/or other characteristics/services at a particular cost, which can be used to rank and compare the different deployment arrangements according to a cost/benefit analysis. During operation 908 of method 900, the deployment arrangements are evaluated to identify a deployment arrangement that may provide a required benefit (e.g., performance, security, storage efficiency, bandwidth, availability, etc.) at a target cost (e.g., a lowest cost).

During operation 910 of method 900, one or more deployment scripts are generated for deploying the service. In order to generate a deployment script to deploy a component of the service to a particular cloud computing platform, the service representation is translated from the cloud provider neutral format into a deployment script formatted according to programming semantics supported by the cloud computing platform. During operation 912 of method 900, the deployment scripts are executed to deploy components of the service across the one or more cloud computing platforms specified by the deployment arrangement selected during operation 908.

In some embodiments, a method is provided. The method includes receiving a service request formatted according to a human readable format, wherein the service request describes a service that is to be deployed; evaluating the service request to determine deployment parameters for deploying the service; evaluating, utilizing the deployment parameters, characteristics of cloud computing platforms to select a deployment arrangement of one or more of the cloud computing platforms for hosting components of the service; generating one or more deployment scripts for deploying the service, wherein for each cloud computing platform of the deployment arrangement, translating the service request from the human readable format to a machine readable format as a deployment script formatted according to programming semantics supported by a cloud computing platform; and executing the one or more deployment scripts to deploy the components of the service across the one or more cloud computing platforms of the deployment arrangement.

In some embodiments, the evaluating the service request to determine the deployment parameters comprises: parsing text of the service request to extract information used to determine the deployment parameters as including at least one of a network configuration for the service, a definition defining how the service is to operate, a load balancer that will be used as part of the service, a database server that will be used as part of the service, a webserver that will be used as part of the service, an amount of compute to allocate to the service, an amount of storage resources to allocate to the service, or a virtual machine that will be used as part of the service.

In some embodiments, the generating one or more deployment scripts comprises: generating a first deployment script formatted according to first programming semantics of a first cloud computing platform, wherein the first deployment script is configured to deploy a first component of the service to the first cloud computing platform; and generating a second deployment script formatted according to second programming semantics of a second cloud computing platform, wherein the second deployment script is configured to deploy a second component of the service to the second cloud computing platform.

In some embodiments, the generating one or more deployment scripts comprises: generating a cloud formation deployment script formatted according to first programming semantics of a first cloud computing platform, wherein the cloud formation deployment script is executed to perform cloud formation through the first cloud computing platform for the service.

In some embodiments, the generating one or more deployment scripts comprises: generating a resource manager deployment script formatted according to second programming semantics of a second cloud computing platform, wherein the resource manager deployment script is executed to create a resource manager hosted through the second cloud computing platform for the service.

In some embodiments, the generating one or more deployment scripts comprises: generating a deployment manager deployment script formatted according to second programming semantics of a second cloud computing platform, wherein the deployment manager deployment script is executed to create a deployment manager hosted through the second cloud computing platform for the service.

In some embodiments, the method comprises: utilizing the deployment parameters, the characteristics of the cloud computing platforms, and the deployment arrangement to generate a deployment plan populated with reasons why the one or more cloud computing platforms of the deployment arrangement were selected and benefits of utilizing the deployment arrangement; and providing the deployment plan to a user in response to the service request for confirmation.

In some embodiments, a computing device is provided. The computing device comprises a memory comprising machine executable code; and a processor coupled to the memory, the processor configured to execute the machine executable code to cause the machine to: in response to receiving a migration request to migrate a service, obtain and translate a current cloud deployment script, used by a first cloud computing platform to host the service, from a machine readable format of the first cloud computing platform into a service representation having a cloud provider neutral format; evaluate, utilizing deployment parameters of the service representation, characteristics of cloud computing platforms to select a deployment arrangement of one or more of the cloud computing platforms for hosting components of the service; generate one or more deployment scripts for migrating the service, wherein for each cloud computing platform of the deployment arrangement, translating the service representation from the cloud provider neutral format to a deployment script formatted according to programming semantics supported by a cloud computing platform; and execute the one or more deployment scripts to deploy the components of the service across the one or more cloud computing platforms of the deployment arrangement.

In some embodiments, the migration request specifies a set of services to migrate, and the machine executable code to causes the machine to: obtain and translate current cloud deployment scripts of the set of services to create a set of service representations; evaluate the set of service representations to identify a first service of the set of services that can be opted out from being migrated based upon the first service being identified as a non-essential service; and provide a recommendation of the deployment arrangement in response to the migration request, wherein the recommendation specifies that the first service can be opted out from being migrated.

In some embodiments, the machine executable code to causes the machine to: implement a recommendation engine to recommend a set of services to migrate based upon a cost of hosting the services within a particular cloud computing platform.

In some embodiments, the machine executable code causes the machine to: generate a set of deployment arrangements that each include a different combination of cloud computing platforms for hosting the components of the service; populate a user interface with the set of deployment arrangements for selection by a user; and in response to receiving a selection of the deployment arrangement from the set of deployment arrangements through the user interface, utilize the deployment arrangement to migrate the service.

In some embodiments, the machine executable code causes the machine to: utilize the deployment parameters and the characteristics of the cloud computing platforms to determine cost and performance metrics of each deployment arrangement of the set of deployment arrangements; and populate the user interface with the cost and performance metrics.

In some embodiments, the machine executable code causes the machine to: evaluate the set of service representations to identify a second service of the set of services as an essential service; and populate the recommendation with an indication that the second service is the essential service that is to be migrated as part of migrating the set of services.

In some embodiments, the machine executable code causes the machine to: execute the one or more deployment scripts to migrate operational metadata of the service from the first cloud computing platform to the one or more cloud computing platforms of the deployment arrangement in a non-disruptive manner where users are capable of accessing the service during the migration of the service.

In some embodiments, the machine executable code causes the machine to: utilize the service representation having the cloud provider neutral format to generate a service description having a human readable format; and populate a user interface with the service description.

In some embodiments, the machine executable code causes the machine to: parse the current cloud deployment script to identify the deployment parameters of the service representation as including at least one of a network configuration for the service, a definition defining how the service is to operate, a load balancer that will be used as part of the service, a database server that will be used as part of the service, a webserver that will be used as part of the service, an amount of compute to allocate to the service, an amount of storage resource to allocate to the service, or a virtual machine that will be used as part of the service.

In some embodiments, a non-transitory machine readable medium is provided. The non-transitory machine readable medium comprises instructions for performing a method, which when executed by a machine, causes the machine to: in response to receiving a migration request to migrate a service from on-premises, obtain and translate metadata of the service into a service representation having a cloud provider neutral format; evaluate, utilizing deployment parameters of the service representation, characteristics of cloud computing platforms to select a deployment arrangement of one or more of the cloud computing platforms for hosting components of the service; generate one or more deployment scripts for migrating the service, wherein for each cloud computing platform of the deployment arrangement, translating the service representation from the cloud provider neutral format to a deployment script formatted according to programming semantics supported by a cloud computing platform; and execute the one or more deployment scripts to deploy the components of the service across the one or more cloud computing platforms of the deployment arrangement.

In some embodiments, the instructions cause the machine to: utilize an application programming interface of a hypervisor hosting the virtual machine to obtain the metadata; evaluate the metadata to determine how the virtual machine is running on-premises; and determine the deployment parameters of the service representation based upon how the virtual machine is running on-premises.

In some embodiments, the instructions cause the machine to: perform a cost comparison between hosting the service on-premises and hosting the service across the one or more cloud computing platforms; and populate a user interface with a result of the cost comparison.

In some embodiments, the instructions cause the machine to: utilize the deployment parameters, the characteristics of the cloud computing platforms, and the deployment arrangement to generate a deployment plan populated with reasons why the one or more cloud computing platforms of the deployment arrangement were selected and benefits of utilizing the deployment arrangement; and provide the deployment plan to a user as a response to the migration request for confirmation.

In some embodiments, the instructions cause the machine to: generate a first deployment script formatted according to first programming semantics of a first cloud computing platform, wherein the first deployment script is configured to deploy a first component of the service to the first cloud computing platform; and generate a second deployment script formatted according to second programming semantics of a second cloud computing platform, wherein the second deployment script is configured to deploy a second component of the service to the second cloud computing platform.

In some embodiments, a method is provided. The method includes determining deployment parameters for a service by evaluating a service request received in a first format; selecting a deployment arrangement of one or more cloud platforms based on the deployment parameters and one or more characteristics of the one or more cloud platforms; generating one or more deployment scripts by translating the service request from the first format to a second format supported by the one or more cloud platforms; and executing the one or more deployment scripts to deploy one or more components of the service across the one or more cloud computing platforms.

In some embodiments, the generating one or more deployment scripts comprises: generating a first deployment script formatted according to first programming semantics of a first cloud computing platform, wherein the first deployment script is configured to deploy a first component of the service to the first cloud computing platform; and generating a second deployment script formatted according to second programming semantics of a second cloud computing platform, wherein the second deployment script is configured to deploy a second component of the service to the second cloud computing platform.

In some embodiments, the generating one or more deployment scripts comprises: generating a cloud formation deployment script formatted according to first programming semantics of a first cloud computing platform, wherein the cloud formation deployment script is executed to perform cloud formation through the first cloud computing platform for the service.

In some embodiments, the generating one or more deployment scripts comprises: generating a resource manager deployment script formatted according to first programming semantics of a first cloud computing platform, wherein the resource manager deployment script is executed to create a resource manager hosted through the first cloud computing platform for the service.

In some embodiments, the generating one or more deployment scripts comprises: generating a deployment manager deployment script formatted according to first programming semantics of a first cloud computing platform, wherein the deployment manager deployment script is executed to create a deployment manager hosted through the first cloud computing platform for the service.

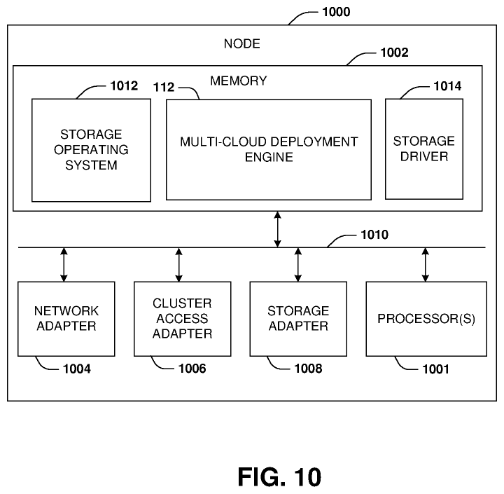

Referring to FIG. 10, a node 1000 (also referred to as a storage node) in this particular example includes processor(s) 1001, a memory 1002, a network adapter 1004, a cluster access adapter 1006, and a storage adapter 1008 interconnected by a system bus 1010. In other examples, the node 1000 comprises a virtual machine, such as a virtual storage machine.

The node 1000 also includes a storage operating system 1012 installed in the memory 1002 that can, for example, implement a RAID data loss protection and recovery scheme to optimize reconstruction of data of a failed disk or drive in an array, along with other functionality such as deduplication, compression, snapshot creation, data mirroring, synchronous replication, asynchronous replication, encryption, etc.

The network adapter 1004 in this example includes the mechanical, electrical and signaling circuitry needed to connect the node 1000 to one or more of the client devices over network connections, which may comprise, among other things, a point-to-point connection or a shared medium, such as a local area network. In some examples, the network adapter 1004 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 1008 cooperates with the storage operating system 1012 executing on the node 1000 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 1008 can include I/O interface circuitry that couples to the disks over an I/O interconnect arrangement, such as a storage area network (SAN) protocol (e.g., Small Computer System Interface (SCSI), Internet SCSI (iSCSI), hyperSCSI, Fiber Channel Protocol (FCP)). The information is retrieved by the storage adapter 1008 and, if necessary, processed by the processor(s) 1001 (or the storage adapter 1008 itself) prior to being forwarded over the system bus 1010 to the network adapter 1004 (and/or the cluster access adapter 1006 if sending to another node computing device in the cluster) where the information is formatted into a data packet and returned to a requesting one of the client devices and/or sent to another node computing device attached via a cluster fabric. In some examples, a storage driver 1014 in the memory 1002 interfaces with the storage adapter to facilitate interactions with the data storage devices.

The storage operating system 1012 can also manage communications for the node 1000 among other devices that may be in a clustered network, such as attached to the cluster fabric. Thus, the node 1000 can respond to client device requests to manage data on one of the data storage devices or storage devices of the distributed storage system in accordance with the client device requests.

A file system module of the storage operating system 1012 can establish and manage one or more file systems including software code and data structures that implement a persistent hierarchical namespace of files and directories, for example. As an example, when a new data storage device (not shown) is added to a clustered network system, the file system module is informed where, in an existing directory tree, new files associated with the new data storage device are to be stored. This is often referred to as “mounting” a file system.

In the example node 1000, memory 1002 can include storage locations that are addressable by the processor(s) 1001 and adapters 1004, 1006, and 1008 for storing related software application code and data structures. The processor(s) 1001 and adapters 1004, 1006, and 1008 may, for example, include processing elements and/or logic circuitry configured to execute the software code and manipulate the data structures.

The storage operating system 1012, portions of which are typically resident in the memory 1002 and executed by the processor(s) 1001, invokes storage operations in support of a file service implemented by the node 1000. Other processing and memory mechanisms, including various computer readable media, may be used for storing and/or executing application instructions pertaining to the techniques described and illustrated herein.

In some embodiments, the multi-cloud deployment engine 112 is implemented by the node 1000 in order to deploy and/or migrate services to cloud computing platforms.

The examples of the technology described and illustrated herein may be embodied as one or more non-transitory computer or machine readable media, such as the memory 1002, having machine or processor-executable instructions stored thereon for one or more aspects of the present technology, which when executed by processor(s), such as processor(s) 1001, cause the processor(s) to carry out the steps necessary to implement the methods of this technology, as described and illustrated with the examples herein. In some examples, the executable instructions are configured to perform one or more steps of a method described and illustrated later.

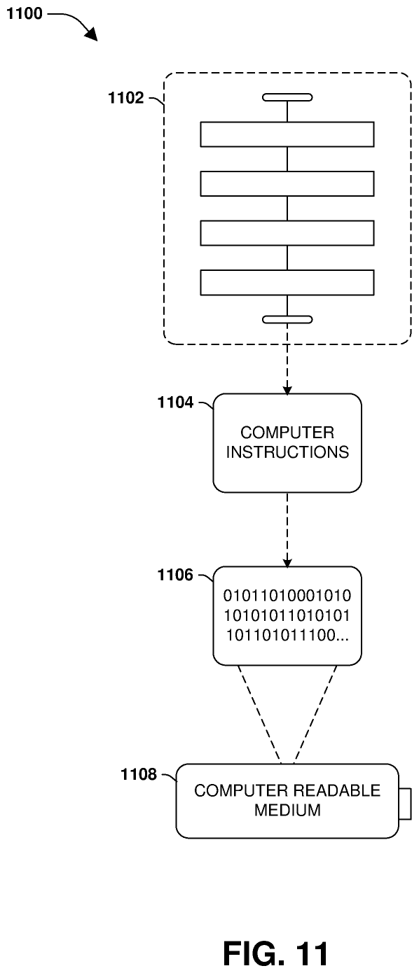

FIG. 11 is an example of a computer readable medium 1100 in which various embodiments of the present technology may be implemented. An example embodiment of a computer-readable medium or a computer-readable device that is devised in these ways is illustrated in FIG. 11, wherein the implementation comprises a computer-readable medium 1108, such as a compact disc-recordable (CD-R), a digital versatile disc-recordable (DVD-R), flash drive, a platter of a hard disk drive, etc., on which is encoded computer-readable data 1106. The computer-readable data 1106, such as binary data comprising at least one of a zero or a one, in turn comprises processor-executable computer instructions 1104 configured to operate according to one or more of the principles set forth herein. In some embodiments, the processor-executable computer instructions 1104 are configured to perform at least some of the exemplary methods 1102 disclosed herein, such as method 700 of FIG. 7, method 800 of FIG. 8, and/or method 900 of FIG. 9, for example. In some embodiments, the processor-executable computer instructions 1104 are configured to implement a system, such as at least some of the exemplary systems disclosed herein, such as system 100 of FIG. 1, system 200 of FIG. 2, and/or system 300 of FIGS. 3A and 3B, for example. Many such computer-readable media are contemplated to operate in accordance with the techniques presented herein.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In some embodiments, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM) s, CD-Rs, compact disk re-writeable (CD-RW) s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving a service request formatted according to a human readable format, wherein the service request describes a service that is to be deployed;
evaluating the service request to determine deployment parameters for deploying the service;
evaluating, utilizing the deployment parameters, characteristics of cloud computing platforms to select a deployment arrangement of one or more of the cloud computing platforms for hosting components of the service;
generating one or more deployment scripts for deploying the service, wherein for each cloud computing platform of the deployment arrangement, translating the service request from the human readable format to a machine readable format as a deployment script formatted according to programming semantics supported by a cloud computing platform; and
executing the one or more deployment scripts to deploy the components of the service across the one or more cloud computing platforms of the deployment arrangement.

2. The method of claim 1, wherein the evaluating the service request to determine the deployment parameters comprises:
parsing text of the service request to extract information used to determine the deployment parameters as including at least one of a network configuration for the service, a definition defining how the service is to operate, a load balancer that will be used as part of the service, a database server that will be used as part of the service, a webserver that will be used as part of the service, an amount of compute to allocate to the service, an amount of storage resources to allocate to the service, or a virtual machine that will be used as part of the service.

3. The method of claim 1, wherein the generating one or more deployment scripts comprises:
generating a first deployment script formatted according to first programming semantics of a first cloud computing platform, wherein the first deployment script is configured to deploy a first component of the service to the first cloud computing platform; and
generating a second deployment script formatted according to second programming semantics of a second cloud computing platform, wherein the second deployment script is configured to deploy a second component of the service to the second cloud computing platform.

4. The method of claim 1, wherein the generating one or more deployment scripts comprises:
generating a cloud formation deployment script formatted according to first programming semantics of a first cloud computing platform, wherein the cloud formation deployment script is executed to perform cloud formation through the first cloud computing platform for the service.

5. The method of claim 1, wherein the generating one or more deployment scripts comprises:
generating a resource manager deployment script formatted according to first programming semantics of a first cloud computing platform, wherein the resource manager deployment script is executed to create a resource manager hosted through the first cloud computing platform for the service.

6. The method of claim 1, wherein the generating one or more deployment scripts comprises:
generating a deployment manager deployment script formatted according to first programming semantics of a first cloud computing platform, wherein the deployment manager deployment script is executed to create a deployment manager hosted through the first cloud computing platform for the service.

7. The method of claim 1, further comprising:
utilizing the deployment parameters, the characteristics of the cloud computing platforms, and the deployment arrangement to generate a deployment plan populated with reasons why the one or more cloud computing platforms of the deployment arrangement were selected and benefits of utilizing the deployment arrangement; and
providing the deployment plan to a user in response to the service request for confirmation.

8. A computing device, comprising:
a memory comprising machine executable code; and
a processor coupled to the memory, the processor configured to execute the machine executable code to cause the machine to:
in response to receiving a migration request to migrate a service, obtain and translate a current cloud deployment script, used by a first cloud computing platform to host the service, from a machine readable format of the first cloud computing platform into a service representation having a cloud provider neutral format;
evaluate, utilizing deployment parameters of the service representation, characteristics of cloud computing platforms to select a deployment arrangement of one or more of the cloud computing platforms for hosting components of the service;
generate one or more deployment scripts for migrating the service, wherein for each cloud computing platform of the deployment arrangement, translating the service representation from the cloud provider neutral format to a deployment script formatted according to programming semantics supported by a cloud computing platform; and
execute the one or more deployment scripts to deploy the components of the service across the one or more cloud computing platforms of the deployment arrangement.

9. The computing device of claim 8, wherein the migration request specifies a set of services to migrate, and wherein the machine executable code causes the machine to:
obtain and translate current cloud deployment scripts of the set of services to create a set of service representations;
evaluate the set of service representations to identify a first service of the set of services that can be opted out from being migrated based upon the first service being identified as a non-essential service; and
provide a recommendation of the deployment arrangement in response to the migration request, wherein the recommendation specifies that the first service can be opted out from being migrated.

10. The computing device of claim 8, wherein the machine executable code causes the machine to:
implement a recommendation engine to recommend a set of services to migrate based upon a cost of hosting the services within a particular cloud computing platform.

11. The computing device of claim 8, wherein the machine executable code causes the machine to:
generate a set of deployment arrangements that each include a different combination of cloud computing platforms for hosting the components of the service;
populate a user interface with the set of deployment arrangements for selection by a user; and
in response to receiving a selection of the deployment arrangement from the set of deployment arrangements through the user interface, utilize the deployment arrangement to migrate the service.

12. The computing device of claim 11, wherein the machine executable code causes the machine to:
utilize the deployment parameters and the characteristics of the cloud computing platforms to determine cost and performance metrics of each deployment arrangement of the set of deployment arrangements; and
populate the user interface with the cost and performance metrics.

13. The computing device of claim 8, wherein the machine executable code causes the machine to:
execute the one or more deployment scripts to migrate operational metadata of the service from the first cloud computing platform to the one or more cloud computing platforms of the deployment arrangement in a seamless manner.

14. The computing device of claim 8, wherein the machine executable code causes the machine to:
utilize the service representation having the cloud provider neutral format to generate a service description having a human readable format; and
populate a user interface with the service description.

15. The computing device of claim 8, wherein the machine executable code causes the machine to:
parse the current cloud deployment script to identify the deployment parameters of the service representation as including at least one of a network configuration for the service, a definition defining how the service is to operate, a load balancer that will be used as part of the service, a database server that will be used as part of the service, a webserver that will be used as part of the service, an amount of compute to allocate to the service, an amount of storage resource to allocate to the service, or a virtual machine that will be used as part of the service.

16. A non-transitory machine readable medium comprising instructions for performing a method, which when executed by a machine, causes the machine to:
in response to receiving a migration request to migrate a service from on-premises, obtain metadata of the service as a service representation;
evaluate, utilizing deployment parameters of the service representation, characteristics of cloud computing platforms to select a deployment arrangement of one or more of the cloud computing platforms for hosting components of the service;
generate one or more deployment scripts for migrating the service, wherein for each cloud computing platform of the deployment arrangement, translate the service representation into a deployment script formatted according to programming semantics supported by a cloud computing platform; and
execute the one or more deployment scripts to deploy the components of the service across the one or more cloud computing platforms of the deployment arrangement.

17. The non-transitory machine readable medium of claim 16, wherein the service is a virtual machine, and wherein the instructions cause the machine to:
utilize an application programming interface of a hypervisor hosting the virtual machine to obtain the metadata;
evaluate the metadata to determine how the virtual machine is running on-premises; and
determine the deployment parameters of the service representation based upon how the virtual machine is running on-premises.

18. The non-transitory machine readable medium of claim 16, wherein the instructions cause the machine to:
perform a cost comparison between hosting the service on-premises and hosting the service across the one or more cloud computing platforms; and
populate a user interface with a result of the cost comparison.

19. The non-transitory machine readable medium of claim 16, wherein the instructions cause the machine to:
utilize the deployment parameters, the characteristics of the cloud computing platforms, and the deployment arrangement to generate a deployment plan populated with reasons why the one or more cloud computing platforms of the deployment arrangement were selected and benefits of utilizing the deployment arrangement; and
provide the deployment plan to a user as a response to the migration request for confirmation.

20. The non-transitory machine readable medium of claim 16, wherein the instructions cause the machine to:
generate a first deployment script formatted according to first programming semantics of a first cloud computing platform, wherein the first deployment script is configured to deploy a first component of the service to the first cloud computing platform; and
generate a second deployment script formatted according to second programming semantics of a second cloud computing platform, wherein the second deployment script is configured to deploy a second component of the service to the second cloud computing platform.

21. A method executed by one or more processors, comprising:
determining deployment parameters for a service by evaluating a service request received in a first format;
selecting a deployment arrangement of one or more cloud platforms based on the deployment parameters and one or more characteristics of the one or more cloud platforms;
generating one or more deployment scripts by translating the service request from the first format to a second format supported by the one or more cloud platforms; and
executing the one or more deployment scripts to deploy one or more components of the service across the one or more cloud computing platforms.

22. The method of claim 21, wherein the generating one or more deployment further comprises:
generating a first deployment script formatted according to first programming semantics of a first cloud computing platform, wherein the first deployment script is configured to deploy a first component of the service to the first cloud computing platform; and
generating a second deployment script formatted according to second programming semantics of a second cloud computing platform, wherein the second deployment script is configured to deploy a second component of the service to the second cloud computing platform.

23. The method of claim 21, wherein the generating one or more deployment further comprises:
generating a cloud formation deployment script formatted according to first programming semantics of a first cloud computing platform, wherein the cloud formation deployment script is executed to perform cloud formation through the first cloud computing platform for the service.

24. The method of claim 21, wherein the generating one or more deployment further comprises:
generating a resource manager deployment script formatted according to first programming semantics of a first cloud computing platform, wherein the resource manager deployment script is executed to create a resource manager hosted through the first cloud computing platform for the service.

25. The method of claim 21, wherein the generating one or more deployment further comprises:
generating a deployment manager deployment script formatted according to first programming semantics of a first cloud computing platform, wherein the deployment manager deployment script is executed to create a deployment manager hosted through the first cloud computing platform for the service.
